(19) United States
(12) Patent Application Publication
(10) Pub. No.: US 2026/0013638 A1
(43) Pub. Date: Jan. 15, 2026

(54) MECHANICAL ACTUATOR AND CHARGING MODULE FOR ADJUSTABLE FURNITURE ITEMS

(71) Applicant: EMOMO TECH (ZHEJIANG) CO., LTD, HUZHOU (CN)

(72) Inventors: WENJI TANG, HUZHOU (CN); ZHIGANG WANG, HUZHOU (CN); YUSHU ZHAO, HUZHOU (CN); JING SONG, HUZHOU (CN)

(21) Appl. No.: 19/266,480

(22) Filed: Jul. 11, 2025

(30) Foreign Application Priority Data
Jul. 12, 2024 (CN) 202421650611.6

(51) Int. Cl. A47C 7/72; A47C 1/034; A47C 3/20; A47C 7/00; F16C 1/14; H02J 7/00

(52) U.S. Cl. CPC A47C 7/72; F16C 1/14; A47C 1/0342; A47C 3/20; A47C 7/004; H02J 7/0042

(57) ABSTRACT

A mechanical actuator and charging module for an adjustable furniture item may include a charging module, a lever, a fulcrum arm, a housing, and a connector. The charging module may include at least one charging interface. The lever may be coupled to a cable of the connector and have a user interface at a first end and a pivot opening at a second end. The fulcrum arm may have a fulcrum pin opening and may be coupled to the lever by a fulcrum pin extending through the fulcrum pin opening and the pivot opening with the fulcrum pin being configured to translate motion of the user interface in a first direction into motion of the cable in a second direction. The housing may include an electronics compartment and enclosing at least a portion of the charging module and at least a portion of the lever.

### CROSS-REFERENCE TO RELATED APPLICATIONS

This application claims priority to CN Application No. 2024216506116 filed Jul. 12, 2024, the entire contents of which are incorporated herein by reference.

### FIELD

This disclosure is directed to a furniture adjustment and electrical charging module incorporating a mechanical actuator for adjusting the adjustable furniture item and an electrical connection for electrically connecting to, e.g., a charging cord such as a Universal Serial Bus (USB) cord for charging electronic devices.

### BACKGROUND

Typically, furniture adjustment mechanisms—e.g., manual and/or mechanical apparatuses—in contrast to electronic controllers, for example, incorporate only the mechanical components and connectors for making adjustments. The mechanical components may include, for example, components for adjusting, locking, and/or unlocking the selected seat height and/or configuration of the furniture item. For example, the mechanical components may include a mechanical actuator—such as a rod—connected to a locking mechanism and operable to release the locking mechanism when a user pulls the rod by pulling a handle accessible to the user and connected to the rod. Similar purely mechanical actuator assemblies are known for adjusting other furniture features such as a degree of recline for the back of the chair or the incline of a footrest. Mechanical actuator assemblies for seat lifting and position adjustments offer advantages such as simplicity of structure, safety, reliability, direct and stable adjustment, durability, low maintenance costs, and adaptability to various environments. In addition, a user need access only the mechanical actuator, such as the handle. The rest of the mechanical actuator assembly may be positioned wherever necessary, such as under the center of the seat.

However, mechanical actuator assemblies are typically embedded behind a surface or component (such as a cover) of the chair or the mechanical actuator assembly or a body (such as a frame) of the chair. The mechanical actuator assembly is thereby protected from dirt and debris but the handle of the mechanical actuator assembly is the only functional component accessible by the user during normal use. Accordingly, known mechanical actuator assemblies are typically limited to specific, pre-set mechanically actuated positions (i.e., height or orientation/configuration) adjustments or related functionality such as locking the position using the handle. For example, known mechanical actuator assemblies do not incorporate other functional features such as electrical features and therefore lack the ability to charge mobile devices or otherwise provide electrical connections in addition to the mechanical actuator assembly.

For at least the reasons above, a mechanical actuator and charging module incorporating, for example, a mechanical actuator assembly and electrical connectors or device charging features would be beneficial to address the technical limitations of the existing designs. A mechanical actuator, lifting chair, and extending chair according to the exemplary embodiments in this disclosure allows users to, e.g., control height adjustments or horizontal extensions via the mechanical actuator while also connecting data cables through the charging module to charge mobile devices, thus achieving multifunctionality.

### BRIEF SUMMARY

According to one aspect, this disclosure is generally directed to an apparatus for controlling adjustable features of furniture items. The apparatus may include a charging module, a level, a connector, a fulcrum arm, and a housing. The charging module may include at least one charging interface. The lever may include a user interface at a first end and a pivot opening at a second end. The connector may include a cable and a sleeve, the cable coupled to the lever, and the sleeve disposed around the cable. The fulcrum arm may have a fulcrum pin opening and coupled to the lever by a fulcrum pin extending through the fulcrum pin opening and the pivot opening. The fulcrum pin may be configured to translate motion of the user interface in a first direction into motion of the cable in a second direction. The housing may include an electronics compartment and enclosing at least a portion of the charging module and at least a portion of the lever. The sleeve may be coupled to the fulcrum arm and translation of motion of the user interface in the first direction into motion of the cable in the second direction via the fulcrum pin causes the cable to move relative to the sleeve.

According to another aspect, the disclosure is generally directed to a system including an adjustable furniture item and a mechanical actuator and charging module. The mechanical actuator and charging module may be coupled to the adjustable furniture item and include a charging module, a level, a fulcrum arm, a housing, and a sleeve. The charging module may include at least one charging interface. The lever may be coupled to a cable of a connector. The fulcrum arm may be configured to translate motion of the lever in a first direction into motion of the cable in a second direction. The housing may enclose at least a portion of the charging module and at least a portion of the fulcrum arm. The sleeve of the connector may be disposed around the cable of the connector. The sleeve may be coupled to the fulcrum arm and translation of motion of the lever in the first direction into motion of the cable in the second direction via the fulcrum arm may cause the cable to move relative to the rope sleeve.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 illustrates a perspective exploded view of a first mechanical actuator and charging module according to an exemplary embodiment.

FIG. 2 illustrates a perspective view showing the first mechanical actuator and charging module in an open state according to an exemplary embodiment.

FIG. 3 illustrates a partially exploded bottom perspective view of the first mechanical actuator and charging module according to an exemplary embodiment.

FIG. 4 illustrates a top-side perspective view of the first mechanical actuator and charging module according to an exemplary embodiment.

FIG. 5 illustrates a top-side cross-sectional view of the first mechanical actuator and charging module according to an exemplary embodiment.

FIG. 6 illustrates perspective view showing a lifting chair in conjunction with a first mechanical actuator and charging module according to an exemplary embodiment.

FIG. 7 illustrates a perspective exploded view of a second mechanical actuator and charging module according to an exemplary embodiment.

FIG. 8 illustrates a top perspective view of the second mechanical actuator and charging module according to an exemplary embodiment.

FIG. 9 illustrates a bottom perspective view of the second mechanical actuator and charging module according to an exemplary embodiment.

FIG. 10 illustrates a bottom-side cross-sectional view of the second mechanical actuator and charging module according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment.”

For purposes of this disclosure, the phrases “devices,” “systems,” and “methods” may be used either individually or in any combination referring without limitation to disclosed components, grouping, arrangements, steps, functions, or processes.

To help those skilled in the art better understand the exemplary embodiments according to this disclosure, the following detailed description sets forth the exemplary embodiments with reference to the accompanying drawings. The disclosure is not limited to the exemplary embodiments but includes other embodiments consistent with this disclosure.

It should be noted that when an element is described as being “fixed to” or “disposed on” another component, it may be directly or indirectly positioned on the other component. When a component is described as being “connected to” another component, it may be directly or indirectly connected to the other component.

It should also be understood that terms such as “length,” “width”, “upper”, “lower”, “front”, “rear”, “left”, “right”, “vertical”, “horizontal”, “top”, “bottom”, “inside”, and “outside” are used to indicate orientations or positional relationships based on the orientations or positional relationships shown in the drawings. These terms are provided for convenience of description and simplified narration, rather than indicating or implying that the devices or components referred to must have specific orientations or be configured and operated in specific orientations. Therefore, they should not be construed as limiting this application.

Furthermore, the terms “first” and “second” are used solely for descriptive purposes and should not be interpreted as indicating relative importance or implying a specific number of the indicated technical features. Accordingly, features described as “first” or “second” may explicitly or implicitly include one or more such features. In this application, the terms “multiple” or “several” refer to two or more unless specifically defined otherwise.

It is important to note that the structures, proportions, and dimensions illustrated in the accompanying drawings are provided solely to complement the description and help those skilled in the art understand and read the content. These drawings are not intended to limit the implementation conditions of this application and have no substantive technical significance. Any modifications to the structures, changes in proportions, or adjustments in dimensions that do not affect the effects and purposes of this application shall still fall within the scope of the technical content disclosed herein.

This disclosure relates generally to devices and methods for adjusting the position or configuration of adjustable (e.g., liftable or extendable) furniture items, including but not limited to, e.g., chairs, sofas, or other furniture items consistent in whole or in relevant part with this disclosure. More specifically, this disclosure is directed generally to furniture adjustment mechanisms incorporated and operable in adjustable furniture items, such as a lifting chair or extending chair assembly. A “liftable” or “lifting” furniture item is adjustable to different heights—e.g., vertically. An “extendable” or “extending” furniture item is adjustable to different configurations or positions—e.g., extending horizontally to a recumbent position.

For example, a lifting chair may be a chair with adjustable height, designed to meet the needs of different users in various settings. Lifting chairs are widely used not only in office environments but also in homes, schools, and medical institutions. For instance, in a household setting, lifting chairs can be placed next to dining or study tables, allowing family members to adjust the seat height based on their height and comfort. Extending chairs are also widely used in various settings and allow a user to change a configuration of the extending chair, for example by adjusting a degree of recline of the seat back and/or elevating a footrest.

The exemplary embodiments address the shortcomings of purely mechanical actuator assemblies embedded in the surface of chair bodies. Purely mechanical assemblies are typically limited to height or configuration adjustment functions and lack the ability to charge mobile devices, resulting in a single-function design.

To resolve this issue, embodiments described hereby provide a mechanical actuator and charging module that integrates a charging module on a first end face of a housing. In addition to controlling lifting or horizontal extension through the mechanical actuator, users can connect a data cable via the charging module to charge mobile devices, achieving multifunctionality.

Some exemplary embodiments are directed generally to a mechanical actuator and charging module for adjusting, lifting, and/or extending a chair with any corresponding adjustability and making electrical connections. The mechanical actuator and charging module, allows users to control height adjustments or horizontal extensions via the pulling member while connecting data cables through the charging module to charge mobile devices—or provide other known or unknown functionality of data connections—thus achieving multifunctionality. Advantageously, the mechanical actuator works even in power outages, ensuring normal operation even when the charging module does not operate. For brevity, unless otherwise stated, “adjusting” or “adjustment” as used in this disclosure will include lifting, extending, and any other adjustment consistent with this disclosure.

For brevity in this disclosure—and without limitation—reference may be made illustratively to a liftable or extendable chair. It is understood, however, that the exemplary embodiments may be used with any furniture item unless expressly noted or inconsistent with this disclosure.

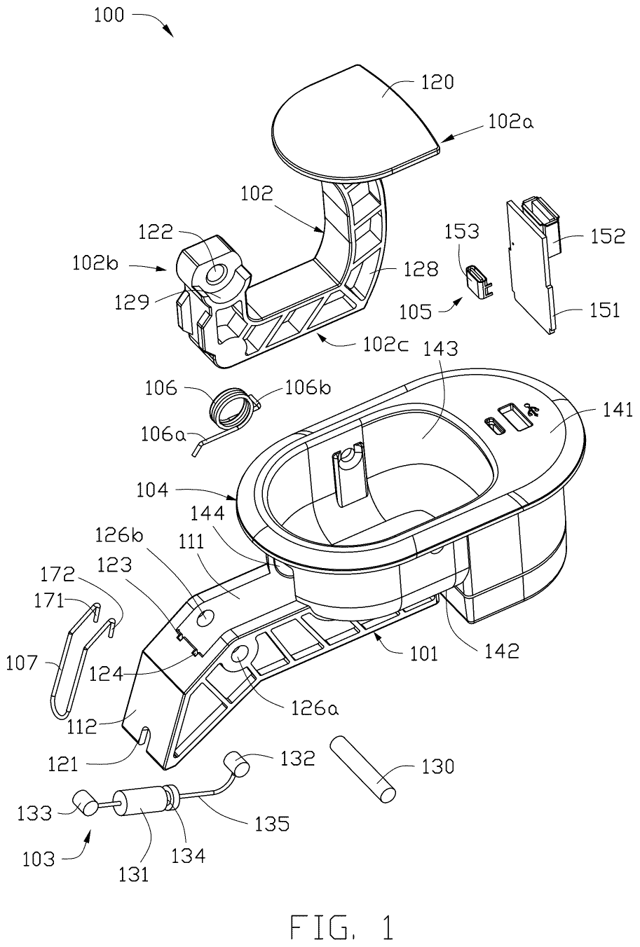

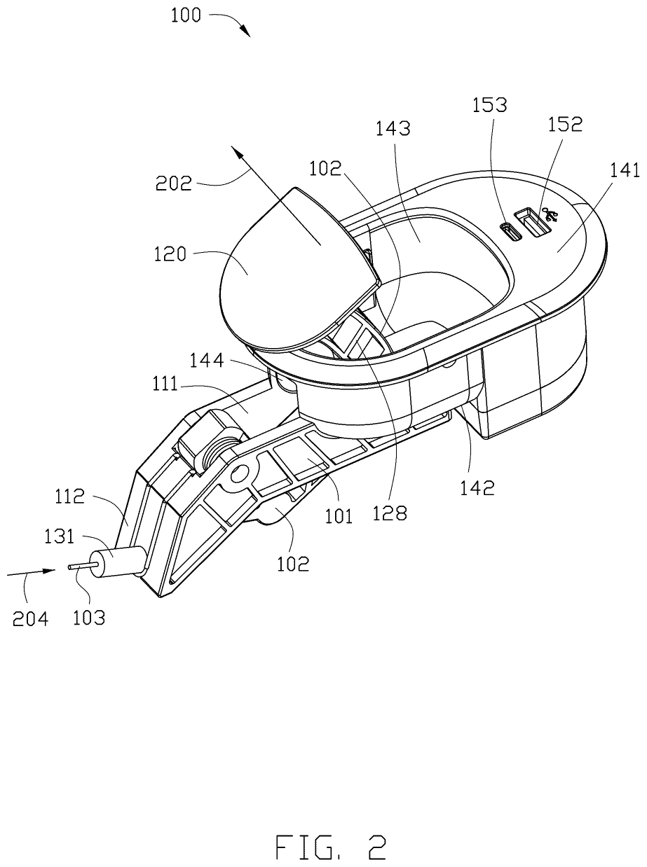

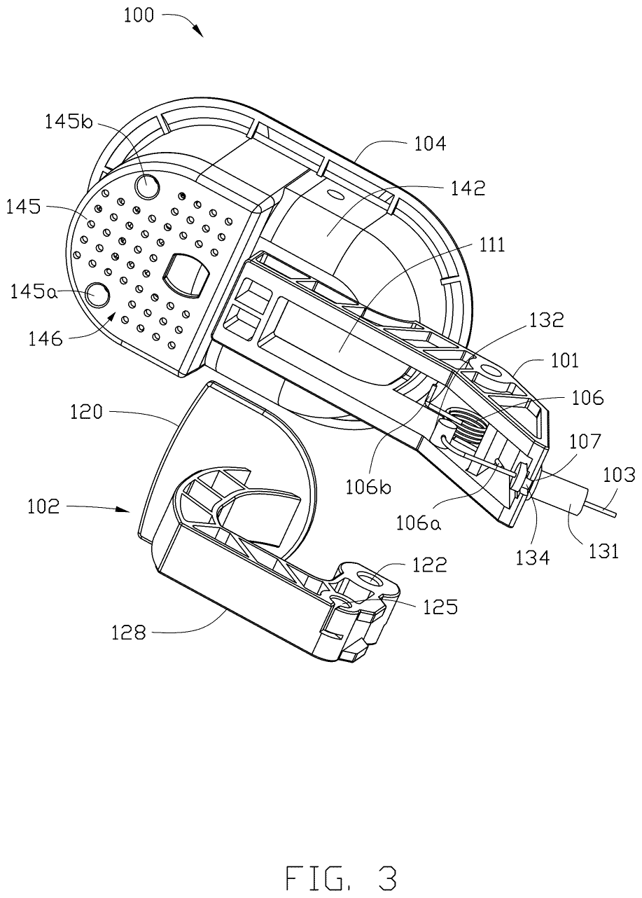

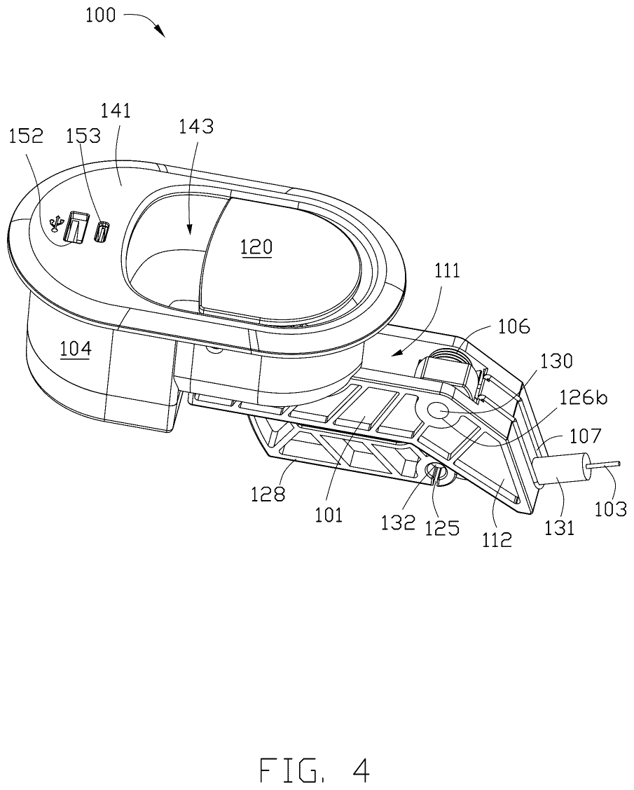

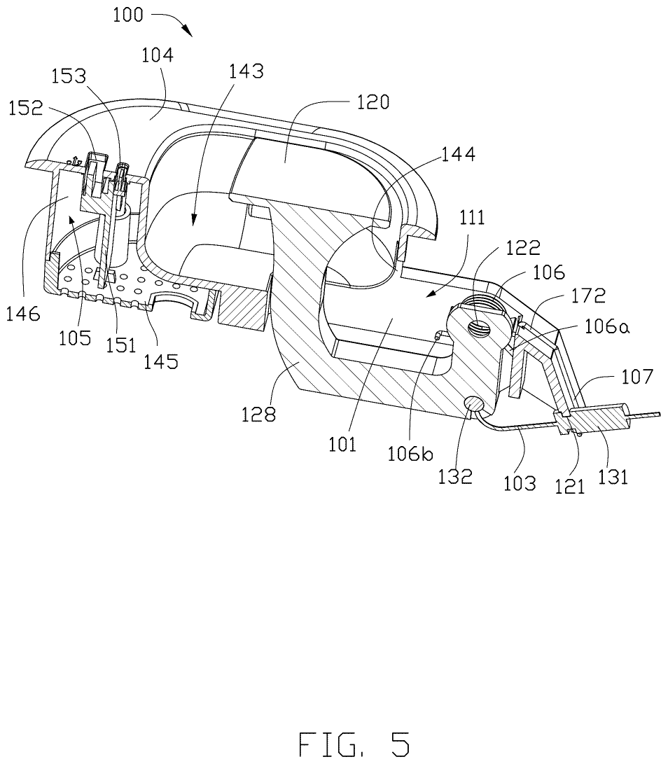

FIGS. 1-5 illustrate various aspects of a first mechanical actuator and charging module 100 according to some embodiments. More specifically, FIG. 1 illustrates a perspective exploded view of the first mechanical actuator and charging module 100, FIG. 2 illustrates a perspective view showing the first mechanical actuator and charging module 100 in an open state, FIG. 3 illustrates a partially-exploded bottom perspective view of the first mechanical actuator and charging module 100, FIG. 4 illustrates a top-side perspective view of the first mechanical actuator and charging module 100, and FIG. 5 illustrates a top-side cross-sectional view of the first mechanical actuator and charging module 100. In various embodiments, the first mechanical actuator and charging module 100 may combine a mechanical actuator assembly for adjusting adjustable furniture items and a charging module for electrically connecting to, e.g., a charging cord such as a Universal Serial Bus (USB) cord for charging electronic devices into a compact and reliable component for furniture items. Embodiments are not limited in this context.

The mechanical actuator and charging module 100 may include a fulcrum arm 101, a lever 102, a connector 103, a housing 104, a charging module 105, a biasing member 106, a retaining clip 107, and a fulcrum pin 130. The connector 103 includes a sleeve 131 and a cable 135. The sleeve 131 includes an annular recess 134 and the cable 135 includes a first coupler pin 132 at a first end and a second coupler pin 133 at a second end. Generally, the lever 102 couples to the fulcrum arm 101 via a fulcrum pin 130, the first coupler pin 132 of the cable 135 of the connector 103 also couples to the lever 102, and the fulcrum pin 130 is configured to translate motion of the lever 102 into motion of the connector 103. For example, as shown in FIG. 2, motion of a user interface 120 in a first direction 202 is translated into motion of the cable 135 in a second direction 204. In some such examples, the first direction 202 and/or second direction 204 may be arcuate directions and/or reversible.

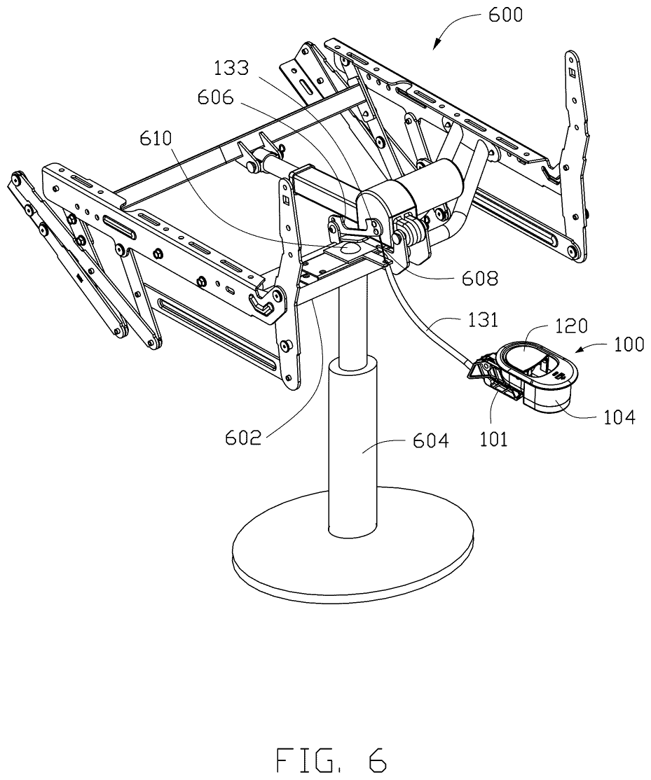

As discussed in more detail below, such as with respect to FIG. 6, in many embodiments, motion of the cable 135 of the connector 103 in the second direction 204 may cause adjustment of a liftable or extendable furniture item. For example, motion of the cable 135 in the second direction 204 may cause a recliner to recline and/or cause a footrest to rise. In some embodiments, the cable 135 comprises a traction rope, resistance member, traction rope body or the like. As previously mentioned, the cable 135 may include the first coupler pin 132 and the second coupler pin 133 at first and second ends, respectively. In several embodiments, the first coupler pin 132 may be coupled to the lever 102 and the second coupler pin 133 may be connected to an adjustability mechanism of the furniture item. Additionally, the sleeve 131 may be disposed around the cable 135. The connector 103 may be free to slide within the sleeve 131. It will be appreciated that the illustrated cable 135 and sleeve 131 are short in length in FIG. 1, but long in FIG. 6, however, any lengths may be utilized without departing from the scope of this disclosure.

The annular recess 134 of the sleeve 131 may be utilized to couple to the fulcrum arm 101, such as via sleeve coupler 121 (see e.g., FIG. 5). The fulcrum arm 101 may include, or be coupled to, one or more portions of the lever 102, connector 103, housing 104, and/or fulcrum pin 130. In the illustrated embodiment, the fulcrum arm 101 extends towards the housing 104. In some embodiments, the fulcrum arm 101 may be integrally formed with the housing 104. In one embodiment, the fulcrum arm 101 includes a changeover connection assembly.

Moving along the fulcrum arm 101 from the sleeve coupler 121 towards the housing 104, the fulcrum arm 101 includes a first barb recess 123 and a second barb recess 124. In various embodiments, the first and second barb recesses 123, 124 are configured to receive corresponding first and second barbs 171, 172 of the retaining clip 107. For example, with annular recess 134 of sleeve 131 positioned in sleeve coupler 121, the retaining clip 107 may be disposed around the sleeve 131 and the first and second barbs 171, 172 may be positioned in the first and second barb recesses 123, 124. In many embodiments, this may prevent the sleeve 131 from sliding out of the sleeve coupler 121. In some embodiments, the sleeve coupler 121 may include a buckle groove (not shown?).

The fulcrum arm 101 may include a lever channel 111 configured to receive at least a portion of the lever 102 (see e.g., FIG. 5). In some embodiments, the barb recesses 123, 124 (see e.g., FIG. 1) may extend from and/or be integrally formed with the lever channel 111. The lever channel 111 may extend into the housing 104. More specifically, the lever channel 111 may extend into an access pocket 143 of the housing 104. In some embodiments, the lever channel 111 is integrally formed with the access pocket 143. Additionally, a travel groove 144 may extend from the access pocket 143 through the housing 104 and above the lever channel 111. In many embodiments, the travel groove 144 may facilitate articulation of the lever 102 when coupled to the fulcrum arm 101 (see e.g., FIGS. 2 and 5).

The lever channel 111 includes a first fulcrum pin opening 126a and a second fulcrum pin opening 126a. One end of the lever 102 may be rotatably connected to the fulcrum arm 101 via the fulcrum pin openings 126a, 126b and fulcrum pin 130. In various embodiments, the lever 102 may be coupled to the fulcrum arm 101 by extending the fulcrum pin 130 through the fulcrum pin opening 126a, pivot opening 122 of the lever 102, and fulcrum pin opening 126b (see e.g., FIG. 4). In the illustrated embodiment, the fulcrum arm 101 includes a connector end 112. Further, the fulcrum pin openings 126a, 126b are positioned at an apex or elbow of the connector end 112. In some embodiments, the connector end 112 may be configured to properly align different components of the first mechanical actuator and charging module 100, such as connector 103 and lever 102, thus making the actuation process labor-saving.

With reference to, for instance, FIG. 1, the lever 102 may include a first end 102a including the user interface 120, a second end 102b including the pivot opening 122 and a biasing member lip 129, and a lever arm 128, including a bottom 102c of the lever 102, connecting the first end 102a and the second end 102b of the lever 102. In some embodiments, the pivot opening 122 may include a hinge interface. In various embodiments, the lever arm 128 may have a U- or J-shape. In various such embodiments, a first leg of the U-shape (e.g., including pivot opening 122) may be shorter than a second leg of the U-Shape (e.g., (including user interface 120). Further, the first leg may be straight and the second leg may include a curved shape. Additionally, the bottom of the U-shape may be straight.

In various embodiments, the biasing member 106 may be positioned on or adjacent to the biasing member lip 129. For example, fulcrum pin 130 may extend through fulcrum pin opening 126a, a middle portion of a biasing member 106, pivot opening 122, and fulcrum pin opening 126b (collectively fulcrum pin openings 126) to couple the lever 102 to the fulcrum arm 101. The user interface 120 may include a place that facilitates application of a lifting force (e.g., in the first direction 202) and/or a pushing force. For example, one or more fingers of a user may be placed on a bottom side of the user interface 120 to apply a lifting force. To this end, the access pocket 143 may be configured to enable a user to access the bottom side of the user interface 120 and apply the lifting force. In some embodiments, the user interface 120 may include one or more ergonomic features, such as smoothed and/or nonslip surfaces. In some embodiments, a topside of the user interface 120 may be configured to receive a pushing force. In various embodiments, the user interface 120 may include a pulling plate.

As previously mentioned, the connector 103 may be equipped with sleeve 131 enshrouding the cable 135; the coupler pin 132 may be detachably connected approximately at the middle of the lever 102; the annular recess 134 of the sleeve 131 may be detachably connected to the fulcrum arm 101; one end of the lever 102 may rotate around the other end of the lever 102; enabling relative movement between the cable 135 and the sleeve 131; and a second end of the cable 135 (at coupler pin 133) may retract (or extend). In various embodiments, this retraction (or extension) may actuate or cause a furniture item to adjust (see e.g., FIG. 6). In some embodiments, the sleeve 131 and coupling of the sleeve to the fulcrum arm 101 may cause motion of the cable 135 in an axial direction between the sleeve 131 and a lifting chair (not shown).

Referring back to the housing 104 and with reference to FIG. 2, the access pocket 143 may be accessed via a first end face 141 of the housing. The fulcrum arm 101 may be connected to a second end face 142. Further, one side of the housing 104 may be provided with the travel groove 144, the travel groove 144 may communicate with the access pocket 143, the other end of the lever 102 may extend into the access pocket 143, and the travel groove 144 may provide space for the lever 102 to achieve rotational movement. It should be appreciated that the first end face 141 can form a top surface of the housing 104, and the second end face 142 can form a portion of a bottom surface of the housing 104.

As shown in FIGS. 1 and 5, the first mechanical actuator and charging module 100 may also include the charging module 105, and the charging module 105 may include an electronics control module 151, a first charging interface 152, and a second charging interface 153. The first end face 141 may provide a surface to expose the first charging interface 152 and the second charging interface 153. Referring to FIG. 5, the electronics control module 151 may be installed within an electronics compartment 146 of the housing 104. The bottom of the electronics compartment 146, which may be enclosed with a vent plate 145. As shown in FIG. 3, the vent plate 145 may be secured to the bottom of the electronics compartment 146 via one or more screws attached via one or more screw holes (see e.g., screw holes 145a, 145b). The vent plate 145 may enable air circulation around the charging module 105 to remove heat generated by the charging module 105.

The electronics control module 151 may be electrically connected to the first charging interface 152 and the second charging interface 153. In various embodiments, the charging interfaces may include one or more of a universal serial bus (USB) interface, Type-C interface, or Micro USB interface. For example, first charging interface 152 may include a USB interface and the second charging interface 153 may include a Type-C interface. The electronics control module 151 may include a charging management IC module, responsible for voltage conversion and management, ensuring voltage stability during the charging process. In many embodiments, the electronics control module 151 may be capable of adjusting according to different charging stages, such as trickle charging, constant current charging, and constant voltage charging. In some embodiments, the electronics control module 151 may determine a device has been connected to the first charging interface 152 prior to providing power to the first charging interface 152. In various embodiments, the electronics control module 151 may determine an amount of power provided via the charging interfaces, such as based on the type of device connected to the charging interface. In some embodiments, the charging module 105 may provide a data connection for a connected device.

The biasing member 106 may be installed at a position where one end of the lever 102 is rotatably connected to the fulcrum arm 101. In some embodiments, the biasing member 106 includes a spring. The other end of the lever 102 may be equipped with the user interface 120. In the initial state, the elastic force of the biasing member 106 may keep the surface of the user interface 120 flush with the first end face 141. In some embodiments, the lever arm 128 of lever 102 can be somewhat U-(or J)-shaped, with a top of one side of the U (at the second end 102b of the lever 102) rotatably connected to the fulcrum arm 101 via pivot opening 122, a bottom portion (bottom 102c of the lever 102), connected to the connector 103 via a receptacle 125 (see e.g., FIG. 3), and the other side of the U (at the first end 102a of the lever 102) connected to the user interface 120. In one embodiment, the fulcrum arm 101 may receive the lever arm 128 through alignment of the pivot opening 122 of the lever arm 128 with the fulcrum pin openings 126 of the fulcrum arm 101. The biasing member 106 may include a first biasing member arm 106a and a second biasing member arm 106b. The first biasing member arm 106a may engage with the fulcrum arm 101 to prevent the biasing member 106 from spinning. The second biasing member arm 106b may prevent too much forward motion of the lever 102 when in the extended position (see e.g., FIG. 5). In some embodiments, the second biasing member arm 106b may bias the lever 102 into a closed state.

As shown in the illustrated embodiment of FIGS. 2, 4 and 5, the fulcrum arm 101 may be provided with the lever channel 111 adapted to the lever 102. One end of the lever channel 111 may be rotatably connected to one end of the lever 102 via pivot opening 122, and the lever channel 111 may communicate with the travel groove 144. One end of the lever 102 may be equipped with the pivot opening 122, and the fulcrum pin 130 (e.g., hinge pin) may pass through the pivot opening 122 of the lever 102 and the biasing member 106 in the lever channel 111.

The top ______ of the fulcrum arm 101 may be connected to the housing 104. As described above, the connector end 112 may be provided at the end ______ of the fulcrum arm 101, opposite from the housing 104, connector end. The connector end 112 may be equipped with the sleeve coupler 121, and the sleeve 131 may be provided with the annular recess 134 (e.g., a ring groove) adapted to the sleeve coupler 121. The annular recess 134 may be buckled to the sleeve coupler 121.

Additionally, the illustrated embodiment includes the retaining clip 107 with the barb 171 and barb 172. In some embodiments, the retaining clip 107 may include an elastic buckle piece (not shown). One end of the retaining clip 107 may be connected to the sleeve 131, and the other end may be clamped into the lever channel 111 via the barb recess 123 and barb recess 124, ensuring that the sleeve 131 is fixed within the sleeve coupler 121. In various embodiments, the retaining clip 107 can be U-shaped, with its opening size adapted to be received within the annular recess 134 of the sleeve 131. The ends of the U-shaped piece are equipped with the barb 171 and the barb 172, and the base of the U-shaped piece may clamp the sleeve 131, and the first and second barbs 171, 172 hook onto the lever channel 111 at barb recess 123 and barb recess 124, respectively.

As shown in FIG. 5, the first end of the cable 135 may be equipped with coupler pin 132 and the second end of the cable 135 may be equipped with second coupler pin 133. Each of the coupler pins 132, 133 may form T-shaped ends of the cable 135. Referring to FIG. 3, the lever 102 is equipped with the receptacle 125 adapted to the shaped end of coupler pin 132. As will be described with respect to FIG. 6, the shaped end of coupler pin 133 may be similarly connected to a lifting chair for actuation of the lifting chair.

FIG. 6 illustrates the first mechanical actuator and charging module 100 in conjunction with a lifting chair 600 according to some embodiments. For the purposes of this disclosure, the lifting chair 600 is an exemplary adjustable (e.g., liftable or extendable) furniture item that can be used in conjunction with mechanical actuator and charging modules described hereby. However, the mechanical actuator and charging modules described hereby may be used in conjunction with any liftable or extendable furniture item without departing from the scope of this disclosure. As shown in FIG. 6, the lifting chair 600 may include a chair frame 602 and a lifting base 604, such that a middle of a bottom of the chair frame 602 may be detachably connected to the lifting base 604. The lifting base 604 may include a control button 610, which extends to the surface of the chair frame 602. On one side of the control button 610 on the chair frame 602, a rocker member 606 may be equipped, one end of the rocker member 606 may be rotatably connected to the chair frame 602, and on the other side of the control button 610 on the chair frame 602, a sleeve coupler 608 may be equipped. The lifting chair 600 may be utilized in conjunction with various embodiments disclosed hereby, such as second mechanical actuator and charging module 700. Embodiments are not limited in this context.

In the illustrated embodiment, the lifting chair 600 includes, or is coupled to, the first mechanical actuator and charging module 100. Accordingly, the annular recess 134 of the sleeve 131 of first mechanical actuator and charging module 100 is detachably connected to the sleeve coupler 608, while the second end of the cable 135 (e.g., coupler pin 133) passes through the sleeve coupler 608 and is detachably connected to the other end of the rocker member 606. Pulling one end of the lever 102 may rotate it around its other end, enabling relative movement between the cable 135 and the sleeve 131. This may cause the second end of the cable 135 (at coupler pin 133) to retract, pressing the middle of the rocker member 606 downward to actuate the control button 610.

In some embodiments, the driving unit of the lifting base 604 can be a hydraulic or pneumatic cylinder, which is used to generate lifting force. The hydraulic cylinder is filled with liquid, such as hydraulic oil, while the pneumatic cylinder is filled with compressed air. When the mechanical actuator and charging module 100 acts on the control button 610 of the lifting base 604 to release the limit, the pressure in the pneumatic cylinder causes the lifting base 604 to act on the chair frame 602, allowing it to slowly rise. Alternatively, when the user sits on the lifting chair and applies downward pressure, the chair frame 602 slowly descends to a height suitable for the user. Once the action of the mechanical actuator and charging module 100 is released, the control button 610 of the lifting base 604 resets, the limit is locked, and the height of the chair frame 602 is fixed. In many embodiments, one or more pieces forming a chair shell (not shown) may be coupled to a??? surface of the chair frame 602. The mechanical actuator and charging module 100 may be mounted to and at least partially housed in the chair shell. For example, the end face 141 of the mechanical actuator and charging module 100 may be flush with a surface of the chair shell.

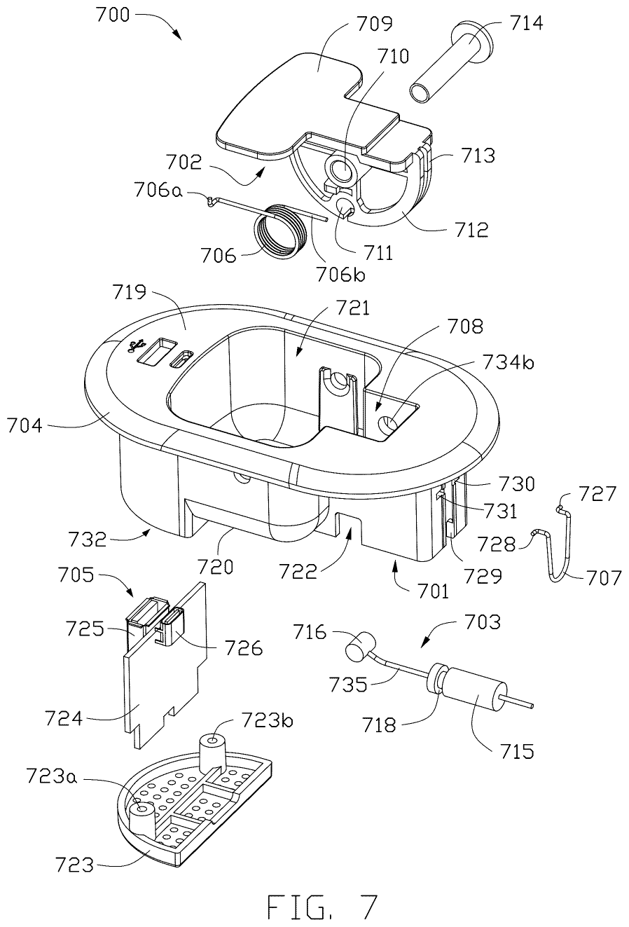

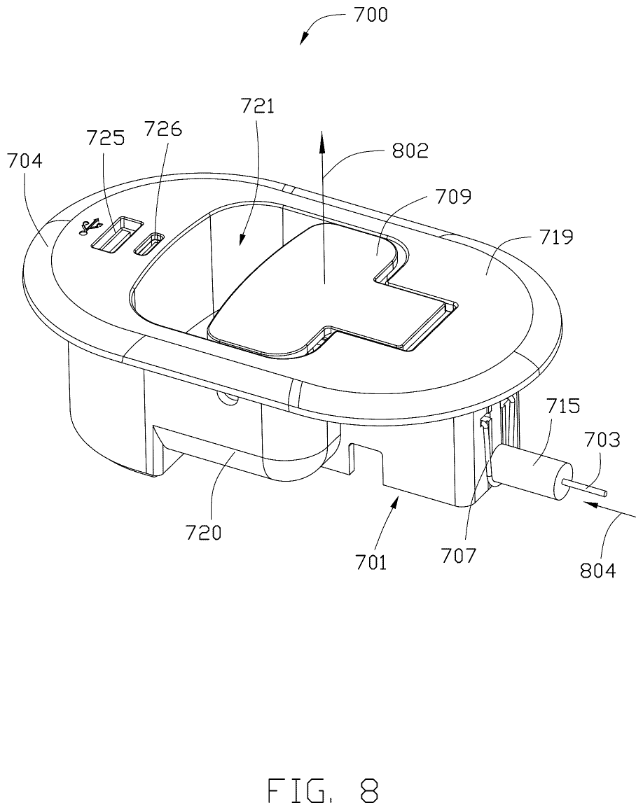

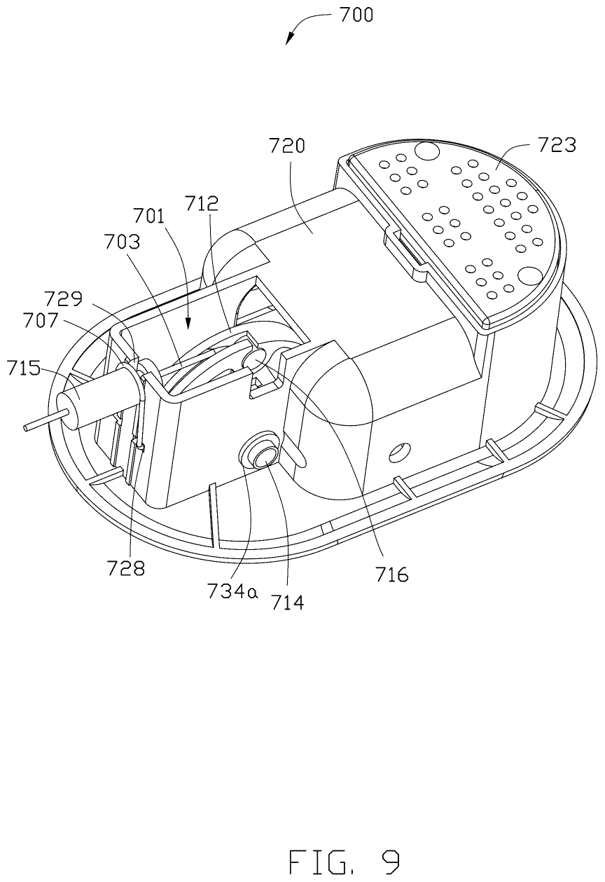

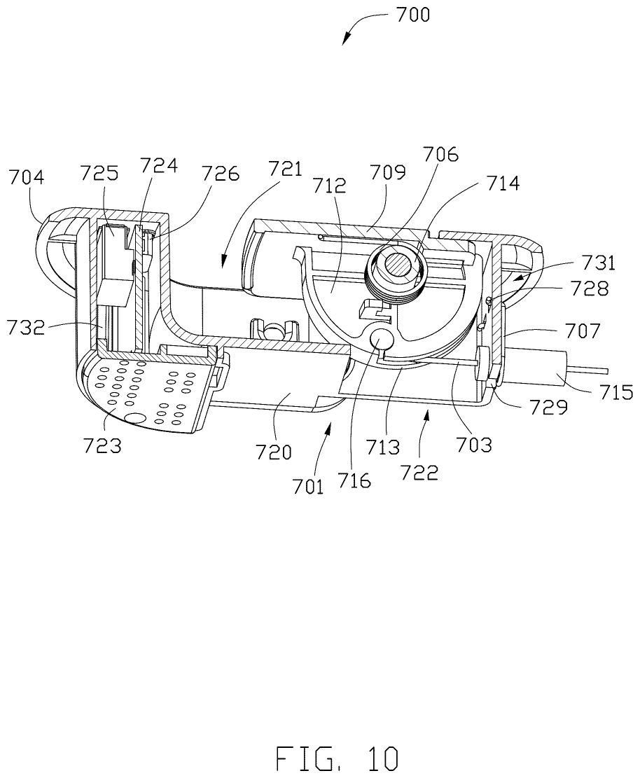

FIGS. 7-10 illustrate various aspects of a mechanical actuator and charging module 700 according to some embodiments. More specifically, FIG. 7 illustrates an exploded structural diagram of the second mechanical actuator and charging module 700, FIG. 8 illustrates a top perspective view of the second mechanical actuator and charging module 700, FIG. 9 illustrates a bottom perspective view of the second mechanical actuator and charging module 700, and FIG. 10 illustrates a cross-sectional view of the second mechanical actuator and charging module 700. The second mechanical actuator and charging module 700 provides a pulling mechanism that integrates a charging module 705 on a first end face 719 of a housing 704. In addition to controlling adjustable furniture items (e.g., lifting chair 600) through a lever 702, users can connect a data cable via the charging module 705 to charge mobile devices, achieving multifunctionality. It will be appreciated that one or more aspects and/or components of the mechanical actuator and charging module 700 may be the same or similar to other mechanical actuator and charging modules described hereby. For example, the connector 703 and/or charging module 705 may be the same or similar to connector 103 and/or charging module 105. Accordingly, description of some aspects and/or components of second mechanical actuator and charging module 700 may not be repeated. Further, as will be appreciated, description of some aspects and/or components of one mechanical actuator and charging module 700 may be applicable to other mechanical actuator and charging modules 100. Embodiments are not limited in this context.

Referring to FIGS. 7 and 9, the second mechanical actuator and charging module 700 includes a fulcrum arm 701, the lever 702, a connector 703, a housing 704, the charging module 705, a biasing member 706, and a retaining clip 707. The connector 703 includes a sleeve 715 and a cable 735. The sleeve includes an annular recess 718 and the cable 735 includes a first coupler pin 716 at a first end and a second coupler pin at a second end (not shown). Generally, the fulcrum arm 701 may include components for converting user input received via the lever 702 into motion of the cable 735. These components are primarily installed into the housing 704 with one end of the cable 735 ultimately being coupled to a lifting chair such that the motion of the cable 735 controls lifting or horizontal extension of the lifting chair. Additionally, charging module 705 facilitates the charging and connectivity functions of the second mechanical actuator and charging module 700.

The housing 704 may include the first end face 719 and a second end face 720. The first end face 719 may include a lever channel 708, an access pocket 721, and openings to expose a first charging interface 725 and a second charging interface 726. The second end face 720 may include a travel groove 722, a sleeve coupler 729, and an opening to access the electronics compartment 732. The opening may be covered by a vent plate 723. For example, screws (not shown) may be utilized to attach the vent plate 723 to the housing 704 via screw holes (e.g., screw holes 723a, 723b). The housing 704 may also include fulcrum pin openings 734a, 734b. In many embodiments, the fulcrum pin openings 734a, 734b may be located in the exterior walls of the lever channel 708 (see e.g., FIGS. 7 and 9).

The charging module 705 may be installed into an electronics compartment 732 of the housing 704 via the opening to receive the vent plate 723 in the second end face 720 of housing 704. The charging module 705 may include a charging control module 724, a first charging interface 725, and a second charging interface 726. It will be appreciated that the charging module 705 may include more or less charging interfaces without departing from the scope of this disclosure. In some embodiments, the charging interfaces may include one or more of a USB interface, Type-C interface, or Micro USB interface. For example, first charging interface 725 may include a USB interface and second charging interface 726 may include a Type-C interface. The charging control module 724 may include a charging management IC module, responsible for voltage conversion and management, ensuring voltage stability during the charging process. In many embodiments, the charging control module 724 may be capable of adjusting according to different charging stages, such as trickle charging, constant current charging, and constant voltage charging. Additionally, the vent plate 723 may enable air circulation around the charging module 705 to remove heat generated by the charging module 705.

The lever 702 may include a user interface 709, a pivot opening 710, a resistance interface 711, an arcuate lever arm 712, and a connector channel 713. The lever 702 may be installed into the lever channel 708 of the housing 704 and secured by extending fulcrum pin 714 through pivot opening 710 and fulcrum pin openings 734a, 734b. Additionally, the fulcrum pin 714 may extend through the biasing member 706 with the biasing member 706 being configured to bias the lever 702 into a down or closed state (see e.g., FIG. 8). To this end, the biasing member 706 may include a first biasing member arm 706a and a second biasing member arm 706b. The first biasing member arm 706a may prevent too much forward motion of the lever 702 when in the extended position. In some embodiments, the first biasing member arm 706a may bias the lever 102 into a closed state. The second biasing member arm 706b may engage with the fulcrum arm 701 to prevent the biasing member 706 from spinning. The resistance interface 711 may receive a coupler pin 716 coupled to the first end of the cable 735 and a portion of the cable 735 may move into and/or pass through the connector channel 713 when the arcuate lever arm 712 is rotated via user interface 709.

The sleeve 715 including the annular recess 718 may be disposed around the cable 735 in a manner that allows relative movement between the cable 735 and the sleeve 715. The annular recess 718 of the sleeve 715 may be installed into the sleeve coupler 729 on the second end face 720 of the housing 704 in conjunction with a retaining clip 707.

The retaining clip 707 may include a U-shaped end and a second end with a first barb 727, a second barb 728, and an opening. The U-shaped end of the retaining clip 707 may be disposed around the sleeve 715 and the second end may be coupled to the housing 704 via a first barb recess 730 and second barb recess 731, ensuring that the sleeve 715 is fixed within the buckle groove first barb recess 730. In various embodiments, the retaining clip 107 can be U-shaped, with its opening size adapted to the sleeve 715. In some embodiments, the base of the U-shaped piece may clamp the sleeve 715, and the first barb 727 and second barb 728 may hook onto the mounting the first barb recess 730 and second barb recess 731, respectively. In various embodiments, the first barb recess 730 and second barb recess 731 may include openings in the housing 704 that the first barb 727 and second barb 728 extend through.

In the top perspective view of the mechanical actuator and charging module 700 shown in FIG. 8, the mechanical actuator and charging module 700 is assembled and in the closed state. A user may slide one or more fingers into the access pocket 721 to lift the user interface 709 and adjust a furniture item coupled to the connector 703. Further, openings in the first end face 719 of the housing 704 may expose the first charging interface 725 and second charging interface 726. Further, motion of the user interface 709 in a first direction 802 may be translated into motion of the cable 735 in a second direction 804. In many embodiments, the first direction 802 and/or second direction 804 may be arcuate directions. In some embodiments, the first direction 802 is an arcuate direction while the second direction 804 is substantially a linear direction.

Referring to FIGS. 9 and 10, the fulcrum arm 701 may include components for converting user input received via the lever 702 into motion of the cable 735. As the user interface 709 is lifted, the arcuate lever arm 712 may be rotated about the fulcrum pin 714, thereby pulling the cable 735 via coupler pin 716 to actuate a furniture item coupled to the other end of the cable 735. As previously mentioned, the sleeve 715 may be installed into the sleeve coupler 729 with retaining clip 707 disposed around the sleeve 715 and the fulcrum pin 714 is installed thorough the arcuate lever arm 712 and the housing 704. Accordingly, the housing 704 may form a portion of the fulcrum arm 701 to enable the fulcrum arm 701 to translate motion of the lever 702 in the first direction 802 into motion of the cable 735 in the second direction 804.

Referring to FIG. 10, the biasing member 706 may bias the fulcrum arm 701 into the closed state by applying a force to rotate the arcuate lever arm 712 in a counterclockwise direction within the travel groove 722. When a user inserts one or more fingers into the access pocket 721 and lifts the user interface 709, the arcuate lever arm 712 is rotated in a clockwise direction within the travel groove 722. In the illustrated embodiment, the clockwise rotation causes the cable 735 to be pulled, via coupler pin 716, in a direction toward the charging control module 724 with a portion of the cable 735 being guided into the connector channel 713. Additionally, FIG. 10 illustrates the retaining clip 707 disposed around the sleeve 715 with second barb 728 extending through the housing 704 via second barb recess 731.

The above description of the disclosed embodiments enables those skilled in the art to implement or use this utility model. Various modifications to these embodiments will be apparent to those skilled in the art. The general principles defined herein can be implemented in other embodiments without departing from the spirit or scope of this utility model. Therefore, this utility model is not limited to the embodiments described herein but should be accorded the broadest scope consistent with the principles and novel features disclosed.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Approximating language, as used herein throughout the specification and claims, may be applied to modify any quantitative representation that could permissibly vary without resulting in a change in the basic function to which it is related. Accordingly, a value modified by a term such as “about” or “approximately” is not to be limited to the precise value specified. Such approximating language may refer to the specific value and/or may include a range of values that may have the same impact or effect as understood by persons of ordinary skill in the art field. For example, approximating language may include a range of +/−10%, +/−5%, or +/−3%. The term “substantially” as used herein is used in the common way understood by persons of skill in the art field with regard to patents, and may in some instances function as approximating language. In some instances, the approximating language may correspond to the precision of an instrument for measuring the value.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. An apparatus for controlling adjustable features of furniture items, comprising:
a charging module comprising at least one charging interface;
a lever comprising a user interface at a first end and a pivot opening at a second end;
a connector comprising a cable and a sleeve, the cable coupled to the lever, and the sleeve disposed around the cable;
a fulcrum arm having a fulcrum pin opening and coupled to the lever by a fulcrum pin extending through the fulcrum pin opening and the pivot opening, the fulcrum pin configured to translate motion of the user interface in a first direction into motion of the cable in a second direction; and
a housing having an electronics compartment and enclosing at least a portion of the charging module and at least a portion of the lever,
wherein the sleeve is coupled to the fulcrum arm and translation of motion of the user interface in the first direction into motion of the cable in the second direction via the fulcrum pin causes the cable to move relative to the sleeve.

2. The apparatus of claim 1, wherein a first end of the cable is coupled to the lever and a second end of the cable is coupled to an adjustable furniture item.

3. The apparatus of claim 1, wherein the lever includes a lever arm coupled to the cable and configured to rotate in response to motion of the lever in the first direction.

4. The apparatus of claim 3, wherein the lever arm includes a first end rotatably coupled to the fulcrum arm, a second end coupled to a user interface, and the cable is coupled to the lever arm between the first end and the second end.

5. The apparatus of claim 4, wherein the lever arm comprises a U-shaped arm and the cable is coupled to a bottom portion of the U-shaped arm.

6. The apparatus of claim 1, wherein the lever comprises an arcuate lever arm coupled to the cable and the arcuate lever arm configured to rotate in response to motion of the lever in the first direction.

7. The apparatus of claim 6, wherein the arcuate lever arm includes a connector channel and a portion of the cable moves into the connector channel when the arcuate lever arm is rotated.

8. The apparatus of claim 1, wherein the at least one charging interface includes a first charging interface and a second charging interface.

9. The apparatus of claim 1, wherein the at least one charging interface includes one or more of a universal serial bus (USB) interface, a Type-C interface, or a Micro USB interface.

10. The apparatus of claim 1, wherein the charging module includes a charging control module enclosed in the electronics compartment of the housing.

11. A system, comprising:
an adjustable furniture item; and
a mechanical actuator and charging module coupled to the adjustable furniture item, the mechanical actuator and charging module including:
a charging module comprising at least one charging interface;
a lever coupled to a cable of a connector;
a fulcrum arm configured to translate motion of the lever in a first direction into motion of the cable in a second direction;
a housing enclosing at least a portion of the charging module and at least a portion of the fulcrum arm; and
a sleeve of the connector disposed around the cable of the connector, wherein the sleeve is coupled to the fulcrum arm and translation of motion of the lever in the first direction into motion of the cable in the second direction via the fulcrum arm causes the cable to move relative to the sleeve.

12. The system of claim 11, wherein a first end of the cable is coupled to the lever and a second end of the cable is coupled to the adjustable furniture item.

13. The system of claim 11, wherein the lever includes a lever arm coupled to the cable and configured to rotate in response to motion of the lever in the first direction.

14. The system of claim 13, wherein the lever arm includes a first end rotatably coupled to the fulcrum arm, a second end coupled to a user interface, and the cable is coupled to the lever arm between the first end and the second end.

15. The system of claim 14, wherein the lever arm comprises a U-shaped arm and the cable is coupled to a bottom portion of the U-shaped arm.

16. The system of claim 11, wherein the fulcrum arm includes an arcuate lever arm coupled to the cable and configured to rotate in response to motion of the lever in the first direction.

17. The system of claim 16, wherein the arcuate lever arm includes a connector channel and a portion of the cable moves into the connector channel when the arcuate lever arm is rotated.

18. The system of claim 11, wherein the at least one charging interface includes a first charging interface and a second charging interface.

19. The system of claim 11, wherein the at least one charging interface includes one or more of a universal serial bus (USB) interface, a Type-C interface, or a Micro USB interface.

20. The system of claim 11, wherein the charging module includes a charging control module enclosed in an electronics compartment of the housing.
